(19) United States
(12) Patent Application Publication
(10) Pub. No.: US 2025/0385557 A1
(43) Pub. Date: Dec. 18, 2025

(54) HYBRID MAGNETIC CIRCUIT PERMANENT MAGNET ELECTRIC MACHINE WITH INTRA-POLE ASYMMETRIC MAGNETIC POLES

(71) Applicant: Shandong University of Technology, Zibo (CN)

(72) Inventors: Wenjing Hu, Zibo (CN); Huihui Geng, Zibo (CN); Liwei Shi, Zibo (CN); Xueyi Zhang, Zibo (CN); Yunfei Shangguan, Zibo (CN); Hongyan Li, Zibo (CN); Guodong Liu, Zibo (CN); Jianwei Li, Zibo (CN); Bo Li, Zibo (CN); Jun Zhang, Zibo (CN)

(73) Assignee: Shandong University of Technology, Zibo (CN)

(21) Appl. No.: 19/315,359

(22) Filed: Aug. 29, 2025

(30) Foreign Application Priority Data
Dec. 3, 2024 (CN) 202411757232.1

(51) Int. Cl. H02K 1/276; H02K 29/03

(52) U.S. Cl. CPC H02K 1/276; H02K 29/03

(57) ABSTRACT

The present disclosure provides a hybrid magnetic circuit permanent magnet electric machine with intra-pole asymmetric magnetic poles, and belongs to the technical field of automobile electric machines and electrical appliances. The electric machine adopts a double-layer permanent magnet structure, comprising an outer symmetrical √-shaped permanent magnet structure, an inner asymmetrical √-shaped permanent magnet structure and reverse √-shaped permanent magnet structure, so that the magnetic pole magnetic field is adjustable and the magnetic field distribution is more uniform, the harmonic content of air-gap flux density is minimized, and torque ripple and electric machine loss are reduced.

### TECHNICAL FIELD

The present disclosure provides a hybrid magnetic circuit permanent magnet electric machine with intra-pole asymmetric magnetic poles, and belongs to the technical field of automobile electric machines and electrical appliances.

### BACKGROUND

In electric machines, harmonics of the air-gap flux density are composed of fluctuation components with different frequencies in the magnetic field, and the fluctuation has a significant impact on the performance of the electric machine. Accordingly, it is necessary to reduce the harmonic content of air-gap flux density and improve the sinusoidality of air-gap flux density. Currently, the technology of reducing the harmonics of air-gap flux density has been proposed. For example, a first patent of the prior art, published in China with the application number: 201610823516.5 sets forth a multi-layer segmented built-in permanent magnet synchronous electric machine rotor for electric vehicle driving, in which a rotor structure with three layers of segmented NdFeB magnetic steel and magnetic barrier is disclosed. By optimizing the pole arc coefficient of each layer of permanent magnets, the harmonic content of the air-gap flux density of the built-in permanent magnet synchronous electric machine rotor is minimized. A second patent published in China, with the application number: 201110380616.2, sets forth a rotor for a built-in permanent magnet electric machine, in which a structure with a plurality of permanent magnets are arranged inside the rotor at intervals, wherein a plurality of air slots are arranged at the ends of adjacent permanent magnets and close to the outer circumference of the rotor, and an approximately sinusoidal air-gap flux density is generated by changing the magnitude of the magnetic reluctance of the rotor. Nevertheless, the rotor with three layers of segmented magnetic steel structure leads to a complicated rotor structure, which increases the manufacturing process and electric machine cost. For the second Patent published in China, the disclosed arrangement of permanent magnets in the rotor causes a depression in the magnetic field at the center of the magnetic pole, which affects the stability of the electric machine.

### SUMMARY

The technical objective of the present disclosure is to overcome the deficiency of the prior art and provide a hybrid magnetic circuit permanent magnet electric machine with intra-pole asymmetric magnetic poles under the premise of ensuring that the processing procedure is not increased, the process difficulty and the electric machine cost are not changed greatly, and the electric machine structure is a double-layer permanent magnet electric machine with three sections of pole arcs, and the three sections of pole arcs are respectively provided with magnetic flux by different permanent magnets, so as to improve the air-gap flux density waveform, reduce the distortion rate of the air-gap flux density waveform, weaken the cogging torque and reduce the magnetic leakage.

The present disclosure adopts a technical solution for solving the technical problem: a hybrid magnetic circuit permanent magnet electric machine with intra-pole asymmetric magnetic poles, including a front end cover, a casing, a stator, a rear end cover, a rotating shaft, a rotor core, a √-shaped slot, a reverse √-shaped slot, a V-shaped slot, and a permanent magnet, including:
four √-shaped slots are uniformly arranged in the rotor core along a circumferential direction, a long side of the √-shaped slot is perpendicular to a center line of the magnetic pole where the √-shaped slot is positioned, and proximal ends of the √-shaped slots are communicated;
a reverse √-shaped slot is arranged between the adjacent √-shaped slots, a long side of the reverse √-shaped slot is perpendicular to a center line of the magnetic pole where the reverse √-shaped slot is positioned, and proximal ends of the reverse √-shaped slot are communicated;
√-shaped slots are arranged in a middle of outer sides of the √-shaped slot and the reverse √-shaped slot, and proximal ends of the √-shaped slot are not communicated;
a radial magnetic barrier slot is arranged between the long side of the √-shaped slot and the long side of the reverse √-shaped slot, the radial magnetic barrier slot is arranged along a diameter direction of the rotor core, and the √-shaped slot and the reverse √-shaped slot are symmetrically arranged at both sides of the radial magnetic barrier slot;
an inner end of the long side of the √-shaped slot is provided with a first magnetic barrier slot, and an inner end of the long side of the reverse √-shaped slot is provided with a second magnetic barrier slot;
the permanent magnet is positioned on a short side of the √-shaped slot, the permanent magnet is positioned on a short side of the reverse √-shaped slot, the permanent magnet is positioned on an outer end of a long side of the √-shaped slot, the permanent magnet is positioned on an outer end of a long side of the reverse √-shaped slot, and the permanent magnet is positioned in the √-shaped slot.

A non-communicating distance of 1.5 mm is arranged between an outer end of a short side of the √-shaped slot and an outer circle of the rotor core; a non-communicating distance of 1.5 mm is arranged between an outer end of a short side of the reverse √-shaped slot and an outer circle of the rotor core;
a non-communicating distance of 1.5 mm is arranged between an outer end of the radial magnetic barrier slot and an outer circle of the rotor core;
a non-communicating distance of 1.5 mm is arranged between an outer end of the √-shaped slot and an outer circle of the rotor core;
an included angle of the √-shaped slot is greater than 90°.

The radial magnetic barrier slot is in communication with a proximal end of the √-shaped slot, and the radial magnetic barrier slot is in communication with a proximal end of the reverse √-shaped slot.

A single magnetic pole adopts a pole arc segmented variable permanent magnet design, and the pole arc coefficient of permanent magnet corresponding to each pole arc is optimized, the pole arc coefficient a₁ of permanent magnet in the short side of the √-shaped slot is 0.21, the pole arc coefficient a₂ of the permanent magnet in the √-shaped slot is 0.27, and the pole arc coefficient a₃ of the permanent magnet in the long side of the √-shaped slot is 0.31. At this time, a distortion rate of the air-gap flux density waveform is 23.1%, and the 5th, 7th and 11th harmonics are greatly reduced.

Compared with the prior art, the present disclosure has the following technical effects:
(1) a double-layer permanent magnet structure is adopted, including an outer symmetrical √-shaped permanent magnet structure, an inner asymmetrical √-shaped permanent magnet structure and reverse √-shaped permanent magnet structure, so that the magnetic pole magnetic field is adjustable and the magnetic field distribution is more uniform;
(2) compared with the conventional symmetrical rotor structure, this structure divides the pole arcs of each magnetic pole into three sections, and the each pole arc magnetic field is provided by different permanent magnets respectively. On the premise of ensuring that the electric machine has sufficient torque density, the harmonic content of air-gap flux density is minimized, and torque ripple and electric machine loss are reduced;
(3) the permanent magnets of adjacent magnetic poles are separated by a radial magnetic barrier, which reduces the rotor mass, reduces the magnetic flux leakage between adjacent magnetic poles and improves the power density;
(4) under the same volume and permanent magnets, the total mass is smaller, the output torque is larger, and it has better electromagnetic performance.

### BRIEF DESCRIPTION OF THE DRAWINGS

FIG. 1 is a schematic diagram of a rotor structure of the present disclosure.

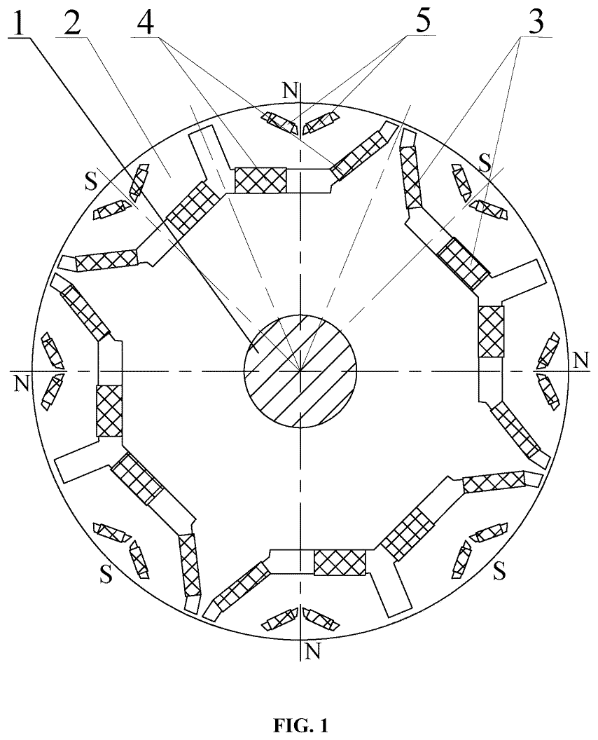

FIG. 2 is a comparison diagram of flux density waveforms for a permanent magnet electric machine of the pole arc segmented variable permanent magnet and a conventional U-shaped permanent magnet electric machine.

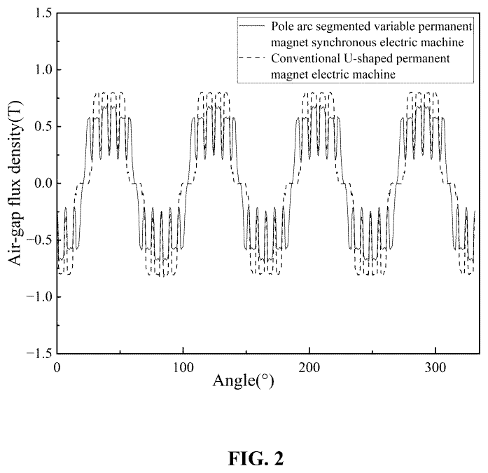

Reference numerals in figures: 1, a rotating shaft; 2, a rotor core; 3, a √-shaped slot; 4, a reverse √-shaped slot; 5, a V-shaped slot.

### DETAILED DESCRIPTION OF THE EMBODIMENTS

A hybrid magnetic circuit permanent magnet electric machine with intra-pole asymmetric magnetic poles, including the front end cover, the casing, the stator, the rear end cover, the rotating shaft, the rotor core, the √-shaped slot, the reverse √-shaped slot, the V-shaped slot, and the permanent magnet, including:
four √-shaped slots 3 are uniformly arranged in the rotor core 2 along the circumferential direction, the included angle of the √-shaped slot 3 is greater than 90°, the long side of the √-shaped slot 3 is perpendicular to the center line of the magnetic pole where the √-shaped slot 3 is positioned, and proximal ends of the √-shaped slots 3 are communicated;
the reverse √-shaped slot 4 is arranged between the adjacent √-shaped slots 3, the included angle of reverse √-shaped slot 4 is greater than 90°, the long side of the reverse √-shaped slot 4 is perpendicular to the center line of the magnetic pole where the reverse √-shaped slot 4 is positioned, and proximal ends of the reverse √-shaped slot 4 are communicated;
the √-shaped slots 5 are arranged in the middle of outer sides of the √-shaped slot 3 and the reverse √-shaped slot 4, the both sides of the √-shaped slot 5 is symmetrical relative to the center line of the magnetic pole, and proximal ends of the √-shaped slot 5 are not communicated;
the radial magnetic barrier slot is arranged between the long side of the √-shaped slot 3 and the long side of the reverse √-shaped slot 4, the radial magnetic barrier slot is arranged along the diameter direction of the rotor core 2, and the √-shaped slot 3 and the reverse √-shaped slot 4 are symmetrically arranged at both sides of the radial magnetic barrier slot;
the inner end of the long side of the √-shaped slot 3 is provided with the first magnetic barrier slot, and the inner end of the long side of the reverse √-shaped slot 4 is provided with the second magnetic barrier slot;
the permanent magnet is positioned on the short side of the √-shaped slot 3, the permanent magnet is positioned on the short side of the reverse √-shaped slot 4, the permanent magnet is positioned on the outer end of the long side of the √-shaped slot 3, the permanent magnet is positioned on the outer end of the long side of the reverse √-shaped slot 4, and the permanent magnet is positioned in the √-shaped slot 5.

The sum of the length of the first magnetic barrier slot and the length of the permanent magnet in the outer end of the long side of the √-shaped slot 3 is equal to the length of the long side of the √-shaped slot 3. The sum of the length of the second magnetic barrier slot and the length of the permanent magnet in the outer end of the long side of the reverse √-shaped slot 4 is equal to the length of the long side of the reverse √-shaped slot 4.

The non-communicating distance of 1.5 mm is arranged between the outer end of the short side of the √-shaped slot 3 and the outer circle of the rotor core 2; the non-communicating distance of 1.5 mm is arranged between the outer end of the short side of the reverse √-shaped slot 4 and the outer circle of the rotor core 2;
the non-communicating distance of 1.5 mm is arranged between the outer end of the radial magnetic barrier slot and the outer circle of the rotor core 2;
the non-communicating distance of 1.5 mm is arranged between the outer end of the V-shaped slot 5 and the outer circle of the rotor core 2, the non-communicating distance of 1.5 mm is arranged between the proximal ends of the V-shaped slots 5;
the included angle of the √-shaped slot is greater than 90°, and the center line of the magnetic pole passes through the first magnetic barrier slot and the second magnetic barrier slot.

The radial magnetic barrier slot is in communication with the proximal end of the √-shaped slot 3, and the radial magnetic barrier slot is in communication with the proximal end of the reverse √-shaped slot 4.

The single magnetic pole adopts the pole arc segmented variable permanent magnet design, and the pole arc coefficient of permanent magnet corresponding to each pole arc is optimized, the pole arc coefficient a₁ of permanent magnet in the short side of the √-shaped slot 3 is 0.21, the pole arc coefficient a₂ of the permanent magnet in the V-shaped slot 5 is 0.27, and the pole arc coefficient a₃ of the permanent magnet in the long side of the √-shaped slot 3 is 0.31. At this time, the distortion rate of air-gap flux density waveform is 23.1%, and the 5th, 7th and 11th harmonics are greatly reduced.

What is claimed is:

1. A hybrid magnetic circuit permanent magnet electric machine with intra-pole asymmetric magnetic poles, comprising a front end cover, a casing, a stator, a rear end cover, a rotating shaft (1), a rotor core (2), a √-shaped slot (3), a reverse √-shaped slot (4), a V-shaped slot (5), and a permanent magnet, wherein:
four √-shaped slots (3) are uniformly arranged in the rotor core along a circumferential direction, wherein a long side of the √-shaped slot (3) is perpendicular to a center line of the magnetic pole where the √-shaped slot (3) is positioned, and proximal ends of the √-shaped slots (3) are communicated;
a reverse √-shaped slot (4) is arranged between the adjacent √-shaped slots (3), a long side of the reverse √-shaped slot (4) is perpendicular to a center line of the magnetic pole where the reverse √-shaped slot (4) is positioned, and proximal ends of the reverse √-shaped slot (4) are communicated;
V-shaped slots (5) are arranged in a middle of outer sides of the √-shaped slot (3) and the reverse √-shaped slot (4), and proximal ends of the V-shaped slot (5) are not communicated;
a radial magnetic barrier slot is arranged between the long side of the √-shaped slot (3) and the long side of the reverse √-shaped slot (4), the radial magnetic barrier slot is arranged along a diameter direction of the rotor core (2), and the √-shaped slot (3) and the reverse √-shaped slot (4) are symmetrically arranged at both sides of the radial magnetic barrier slot;
an inner end of the long side of the √-shaped slot (3) is provided with a first magnetic barrier slot, and an inner end of the long side of the reverse √-shaped (4) slot is provided with a second magnetic barrier slot;
the permanent magnet is positioned on a short side of the √-shaped slot (3), the permanent magnet is positioned on a short side of the reverse √-shaped slot (4), the permanent magnet is positioned on an outer end of a long side of the √-shaped slot (3), the permanent magnet is positioned on an outer end of a long side of the reverse √-shaped slot (4), and the permanent magnet is positioned in the V-shaped slot (5).

2. The hybrid magnetic circuit permanent magnet electric machine with intra-pole asymmetric magnetic poles according to claim 1, wherein:
a non-communicating distance of 1.5 mm is arranged between an outer end of a short side of the √-shaped slot (3) and an outer circle of the rotor core (2), and a non-communicating distance of 1.5 mm is arranged between an outer end of a short side of the reverse √-shaped slot (4) and an outer circle of the rotor core (2);
a non-communicating distance of 1.5 mm is arranged between an outer end of the radial magnetic barrier slot and an outer circle of the rotor core (2);
a non-communicating distance of 1.5 mm is arranged between an outer end of the V-shaped slot (5) and an outer circle of the rotor core (2); and,
an included angle of the √-shaped slot (3) is greater than 90°.

3. The hybrid magnetic circuit permanent magnet electric machine with intra-pole asymmetric magnetic poles according to claim 1, wherein:
the radial magnetic barrier slot is in communication with a proximal end of the V-shaped slot (3), and the radial magnetic barrier slot is in communication with a proximal end of the reverse √-shaped slot (4).

4. The hybrid magnetic circuit permanent magnet electric machine with intra-pole asymmetric magnetic poles according to claim 1, wherein:
the pole arc of each magnetic pole is divided into three sections, and each pole arc magnetic field is provided by different permanent magnets, respectively,
wherein a first pole arc magnetic field in the magnetic pole where the √-shaped slot (3) is positioned is provided by permanent magnets on the short side of the √-shaped slot (3);
a second pole arc magnetic field in the magnetic pole where the √-shaped slot (3) is positioned is provided by permanent magnets on both sides of the V-shaped slot (5; and,
a third pole arc magnetic field in the magnetic pole where the √-shaped slot (3) is positioned is provided by permanent magnets on the outer end of the long side of the √-shaped slot (3).
